(19) United States
(12) Patent Application Publication
(10) Pub. No.: US 2011/0020643 A1
(43) Pub. Date: Jan. 27, 2011

(54) SURFACE PROTECTIVE SHEET

(76) Inventors: Mikihiro Endo, Tokyo (JP); Yusuke Sugiyama, Tokyo (JP); Syuji Ichimura, Tokyo (JP)

Correspondence Address: HOLTZ, HOLTZ, GOODMAN & CHICK PC, 220 Fifth Avenue, 16TH Floor, NEW YORK, NY, 10001-7708, US

(21) Appl. No.: 12/921,541

(22) PCT Filed: Mar. 10, 2008
(86) PCT No.: PCT/JP2008/054312

§ 371 Date: Sep. 8, 2010

(51) Int. Cl. C09J 7/02; B32B 27/18

(52) U.S. Cl. 428/355 BL; 428/355 EN

(57) ABSTRACT

The present invention is directed to a surface protective sheet having a pressure-sensitive adhesive comprised a thermoplastic elastomer as a main component on at least one surface of a substrate, wherein the pressure-sensitive adhesive comprises a hydrogenation product of styrene random copolymer, an amorphous polypropylene elastomer, a tackifier resin, and a softener, wherein hydrogenation product of styrene random copolymer:amorphous polypropylene elastomer is more than 0:less than 100 to less than 80:more than 20, when the total of the hydrogenation product of styrene random copolymer and the amorphous polypropylene elastomer is taken as 100.

### FIELD OF THE INVENTION

The present invention relates to a surface protective sheet for protecting a metal surface, a glass surface, a coating surface, and others, especially for protecting a topcoat coated surface of a automobile.

### BACKGROUND ART

Conventionally, as a method for protecting a topcoat coated surface of the surface of a car body on which coating was completed, for example, application of a plastic sheet having a pressure-sensitive adhesive layer onto an adherend has been known. For example, patent documents 1 to 4 disclose a surface protective sheet which has excellent adhesion and no sticking trace on the coating surface. However, the coating completed car which affixes the surface protective sheet is carried by a transport trailer and transported at a high speed, and exposed to an extremely strong wind during the transport. In addition, the surface of the car body is exposed to extremely severe conditions at a high temperature due to direct sunlight in summer and at a temperature as low as −10 to −20° C. in winter. In the past, there has unfortunately not existed a surface protective sheet having ideal adhesion, sticking trace, low-temperature adhesive strength, high-temperature adhesive strength under all the above severe conditions.

Patent document 1: Japanese Unexamined Patent Publication No. Hei 06-240215

Patent document 2: Japanese Unexamined Patent Publication No. Hei 06-240216

Patent document 3: Japanese Unexamined Patent Publication No. Hei 07-241960

Patent document 4: Japanese Unexamined Patent Publication No. Hei 09-239915

### DISCLOSURE OF THE INVENTION

### Problems to be Solved by the Invention

It is an object of the present invention to provide a surface protective sheet which exhibits excellent adhesion properties to an adherend under the conditions of not only ordinary temperature but also high and low temperatures, and leaves behind neither soiling nor sticking trace on the adherend after the surface protective sheet is peeled off the adherend, and further can be easily peeled off.

### Means to Solve the Problems

The present invention is directed to:

(1) a surface protective sheet having a pressure-sensitive adhesive on at least one surface of a substrate, characterized in that the pressure-sensitive adhesive comprises a hydrogenation product of styrene random copolymer, an amorphous polypropylene elastomer, a tackifier resin, and a softener, wherein the hydrogenation product of styrene random copolymer:the amorphous polypropylene elastomer=more than 0:less than 100 to less than 80: more than 20, when the total of the hydrogenation product of styrene random copolymer and the amorphous polypropylene elastomer is taken as 100;

(2) the surface protective sheet according to item (1) above; wherein the hydrogenation product of styrene random copolymer is a hydrogenation product of a styrene-butadiene random copolymer;

(3) the surface protective sheet according to item (1) or (2) above, characterized in that the tackifier resin is comprised of a hydrogenated rosin ester resin and/or a hydrogenated terpene resin;

(4) the surface protective sheet according to any one of items (1) to (3) above, wherein the softener is at least one selected among an oil, a paraffin wax, a low molecular-weight polybutene, a low molecular-weight polyisoprene, and a low molecular-weight polyisobutylene, and

(5) the surface protective sheet according to any one of items (1) to (4) above, characterized in that the pressure-sensitive adhesive contains at least one selected among an antioxidant, an ultraviolet absorber, an ultraviolet stabilizer (HALS), an antistatic agent, and a lubricant.

### EFFECT OF THE INVENTION

In the present invention, there is provided a surface protective sheet which has excellent adhesion properties to an adherend and excellent peel properties from the adherend not only at ordinary temperature but also at high and low temperatures and exhibits little increases in adhesive strength after being heated. Further, the surface protective sheet of the present invention exhibits little soiling and sticking trace on the adherend surface and also is excellent in weather resistance. In addition, the process for producing the surface protective sheet of the present invention is simple, and the surface protective sheet can be produced not only by a hot melt method but also by solution coating method.

### BEST MODE FOR CARRYING OUT THE INVENTION

Hereinbelow, the present invention will be described in detail.

The term “substrate” used in the present invention means a support or surface material (surface portion of the surface protective sheet before having a pressure-sensitive adhesive) of the surface protective sheet, and may be in the form of either a film or a sheet. In the present invention, the “film” and “sheet” can be used as terms having the same meaning. Examples of resins used for the substrate include polyolefin resins, such as polyethylene, polypropylene, ethylene/α-olefin copolymers, ethylene-vinyl acetate copolymers, etc., nylon resins, polyester resins and so forth. These materials may be used individually or in combination in the form of a mixture or a multilayer. A non-thermoplasticity film, such as nonwoven fabric, woven fabric, paper, metal deposited film, metal, etc., can also be used as the substrate.

The resin used in the substrate is preferably a polyolefin resin or a polyester resin, more preferably a polyolefin resin.

On one surface of the substrate, preferably on the opposite side of the surface of the substrate having a pressure-sensitive adhesive thereon, a design, such as a letter, information, a pattern, a drawing, a picture, etc., or a single color may be printed, and further, for removing air bubbles which tend to be easily taken in during sticking, a continuously uneven pattern may be provided.

The substrate may contain titanium oxide or carbon black for the purpose of blocking an ultraviolet ray. Further, if necessary, the substrate may contain at least one selected among an antioxidant, an ultraviolet absorber, an ultraviolet stabilizer (HALS), an antistatic agent, and a lubricant within a range that dose not impair the object of the present invention.

The substrate film or sheet may be of either a single layer or a multilayer. The surface protective sheet can be prepared by applying a pressure-sensitive adhesive to the substrate film or sheet by a spread coating method or extrusion coating (hot melt coating) method.

The term “surface protective sheet” used in the present invention means a sheet (pressure-sensitive adhesive sheet) comprising of the above-described substrate and a pressure-sensitive adhesive, which is used for the purpose of protecting a metal surface, a glass surface, a plastic surface, a rubber surface, a coating surface, etc, of a product during transport or storage of the product or when processing the product. In the present invention, the “surface protective sheet” and “pressure-sensitive adhesive sheet” can be used as terms having the same meaning.

In the present invention, the “hydrogenation product of styrene random copolymer” is a hydrogenation product of a random copolymer comprising of styrene (1 to 50% by weight)-a diene hydrocarbon (99 to 50% by weight). Examples of hydrogenation products of the styrene-diene random copolymer include a hydrogenation product of a styrene-butadiene random copolymer and a hydrogenation product of a styrene-isoprene random copolymer. Preferred is a hydrogenation product of a styrene-butadiene random copolymer. The commercially available product is not particularly limited as long as it is a hydrogenation product of styrene random copolymer, but preferred are those having a styrene content of 5 to 15% by weight, for example, DYNARON 1320P (hydrogenated styrene-butadiene rubber, styrene content 10% by weight), manufactured by JSR Corporation.

The term “amorphous polypropylene elastomer” used in the present invention means a polypropylene elastomer having a (weight of the crystalline portion)/(weight of the whole polymer) ratio of 0.5 or less. The polypropylene elastomer is preferably a propylene-α-olefin copolymer elastomer (wherein the α-olefin does not include ethylene and propylene). The commercially available product is not particularly limited, but preferred are perfect amorphous products ((weight of the crystalline portion)/(weight of the whole polymer) ratio is 0), for example, Tafthren X1102, manufactured by Sumitomo Chemical Co., Ltd.

The weight of the crystalline portion can be determined from a crystallinity (mass fraction of the crystalline portion, based on the total mass). The crystallinity can be determined from an X-ray diffraction pattern of a polymer (S. Krimm, A. V. Tobolsky: J. Polymer Sci., 7, 57 (1951)).

In the present invention, the weight ratio of the “hydrogenation product of styrene random copolymer” to the “amorphous polypropylene elastomer” has “hydrogenation product of styrene random copolymer” “amorphous polypropylene elastomer”=more than 0:less than 100 to less than 80:more than 20, preferably 20:80 to 70:30, more preferably 40:60 to 70:30, especially preferably 50:50 to 70:30, especially further preferably 55:45 to 65:35, when the total of the “hydrogenation product of styrene random copolymer” and the “amorphous polypropylene elastomer” is taken as 100.

The term “tackifier resin” used in the present invention means a substance having a function to impart tackiness to a thermoplastic elastomer. At least one selected among a rosin resin, a terpene resin, a coumarone-indene resin, a styrene resin, an aliphatic, alicyclic and aromatic petroleum resin can be used as the tackifier resin.

Preferred tackifier resins are a rosin resin and a terpene resin. These resins may be used individually or in combination.

Examples of rosin resins include rosin resins, rosin ester resins, hydrogenated rosin ester resins, etc Examples of terpene resins include terpene resins, hydrogenated terpene resins, etc.

More preferred tackifier resins are a hydrogenated rosin ester resin and a hydrogenated terpene resin. These resins may be used individually or in combination.

In the case where a rosin resin and a terpene resin are used in combination, the weight ratio of the rosin resin to the terpene resin has rosin resin terpene resin=0:100 to 100:0, preferably 10:90 to 90:10, more preferably 15:85 to 85:15, especially preferably 15:85 to 50:50, when the total of the rosin resin and the terpene resin is taken as 100.

Examples of commercially available products of the tackifier resin include PINECRYSTAL KE100, KE311 (hydrogenated rosin ester resin), ESTER GUM H, HP, manufactured by Arakawa Chemical Industries, Ltd.; PENTALYN H, FORAL 85, 105, manufactured by Rika Hercules Inc., and Clearon K100 (hydrogenated terpene resin), K110, manufactured by YASUHARA CHEMICAL CO., LTD.; but the commercially available product is not limited to those mentioned above as long as it is a commercially available product having a function to impart tackiness to a thermoplastic elastomer.

The amount of the tackifier resin in the pressure-sensitive adhesive is, relative to 100 parts of the total of the “hydrogenation product of styrene random copolymer” and the “amorphous polypropylene elastomer”, 1 to 60 parts, preferably 3 to 50 parts, more preferably 5 to 45 parts.

In the present invention, the “softener” indicates a substance having a function to control the tackiness of the pressure-sensitive adhesive at low temperatures, and, as the softener, at least one selected among an oil, a paraffin wax, a low molecular-weight polybutene, a low molecular-weight polyisoprene, a low molecular-weight polyisobutylene, and a low molecular-weight polyolefin can be used in the present invention. Preferred are a low molecular-weight polybutene and a low molecular-weight polyisobutylene.

Examples of oils used as the softener include paraffin oils, aromatic oils, naphthene oils, etc., and examples of commercially available products of the oil used as the softener include, but are not limited to, Nisseki Hisol SAS, manufactured by Nippon Petrochemicals Co., Ltd. and so forth.

Examples of paraffin waxes used as the softener include paraffin waxes, polyethylene waxes, etc., and examples of commercially available products of the paraffin wax used as the softener include, but are not limited to, 125° F. Paraffin, manufactured by Nippon Petrochemicals Co., Ltd. and so forth.

The low molecular-weight polyisobutylene used as the softener means polyisobutylene having a viscosity average molecular weight of about 5,000 to 50,000, and examples of commercially available products of the low molecular-weight polyisobutylene used as the softener include, but are not limited to, Tetrax 3T, manufactured by Nippon Petrochemicals Co., Ltd. and so forth.

The low molecular-weight polybutene used as the softener means liquid polybutene having an average molecular weight of about 200 to 5,000, and examples of commercially available products of the low molecular-weight polybutene used as the softener include, but are not limited to, Idemitsu Polybutene, manufactured by Idemitsu Kosan Co, Ltd.; and Nisseki Polybutene HV100, HV300, manufactured by Nippon Petrochemicals Co., Ltd. and so forth.

The low molecular-weight polyisoprene used as the softener means liquid polyisoprene having an average molecular weight of several thousand to about 60,000, and examples of commercially available products of the low molecular-weight polyisoprene used as the softener include, but are not limited to, KURAPRENE LIR, manufactured by KURARAY CO., LTD. and so forth.

The low molecular-weight polyolefin used as the softener means an ethylene polymer having a number average molecular weight of 500 to 10,000, and examples of commercially available products of the low molecular-weight polyolefin used as the softener include, but are not limited to, commercially available products of low molecular-weight polyethylene, such as Epolene, manufactured by Eastman Chemical Company, and commercially available products of low molecular-weight polypropylene, such as APP, and so forth.

The amount of the softener in the pressure-sensitive adhesive is, relative to 100 parts of the total of the “hydrogenation product of styrene random copolymer” and the “amorphous polypropylene elastomer”, 0.1 to 60 parts, preferably 1 to 50 parts, more preferably 10 to 40 parts.

The term “antioxidant” used in the present invention means a substance having a function to prevent the pressure-sensitive adhesive from suffering a change of the adhesive strength and a lowering of the cohesive force caused by oxidative deterioration. Examples of antioxidants include phenolic antioxidants, phosphite antioxidants, and thioether antioxidants, etc., and, if necessary, the pressure-sensitive adhesive described in the present invention can contain at least one of the above-mentioned antioxidants within a range that dose not impair the object of the present invention (for example, 5 parts or less, relative to 100 parts of the total of the “hydrogenation product of styrene random copolymer” and the “amorphous polypropylene elastomer”). Examples of commercially available products of the antioxidant include, but are not limited to, Antage W500, W400, W300, BHT, SP, DBH, DHA, Crystal, manufactured by Kawaguchi Chemical Industry Co., Ltd.; and Sumilizer TPL, TTP, manufactured by Sumitomo Chemical Co., Ltd. and so forth.

The term “ultraviolet absorber” used in the present invention means a substance having a function to prevent photooxidative deterioration by absorbing an ultraviolet ray Examples of ultraviolet absorbers include benzotriazole ultraviolet absorbers, benzophenone ultraviolet absorbers, and inorganic ultraviolet absorbers, such as cerium oxide fine particles, etc. and, if necessary, the pressure-sensitive adhesive described in the present invention can contain at least one of the above-mentioned ultraviolet absorbers within a range that dose not impair the object of the present invention (for example, 5 parts or less, relative to 100 parts of the total of the “hydrogenation product of styrene random copolymer” and the “amorphous polypropylene elastomer”). Examples of commercially available products of the ultraviolet absorber include, but are not limited to, TINUVIN 326, TINUVIN manufactured by Ciba Specialty Chemicals Inc. and so forth.

Examples of “ultraviolet stabilizers” used in the present invention include hindered amine (HALS) ultraviolet stabilizers and benzoate ultraviolet stabilizers, and, if necessary, the pressure-sensitive adhesive described in the present invention can contain at least one of the above-mentioned ultraviolet absorbers within a range that dose not impair the object of the present invention (for example, 5 parts or less, relative to 100 parts of the total of the “hydrogenation product of styrene random copolymer” and the “amorphous polypropylene elastomer”).

If necessary, the pressure-sensitive adhesive described in the present invention can contain at least one of an inorganic filler and an organic filler within a range that dose not impair the object of the present invention (for example, 5 parts or less, relative to 100 parts of the total of the “hydrogenation product of styrene random copolymer” and the “amorphous polypropylene elastomer”). Examples of inorganic fillers include talc and calcium carbonate, etc., and examples of organic fillers include polyethylene fine particles, etc.

If necessary, the pressure-sensitive adhesive described in the present invention can contain at least one of an antistatic agent and a lubricant within a range that does not impair the object of the present invention (for example, 5 parts or less, relative to 100 parts of the total of the “hydrogenation product of styrene random copolymer” and the “amorphous polypropylene elastomer”).

The term “antistatic agent” used in the present invention means a substance having a function to prevent the generation of static electricity Examples of antistatic agents include surfactants, conductive resins, conductive fillers, etc., and, if necessary, the pressure-sensitive adhesive described in the present invention can contain at least one of the above-mentioned antistatic agents within a range that dose not impair the object of the present invention (for example, 5 parts or less, relative to 100 parts of the total of the “hydrogenation product of styrene random copolymer” and the “amorphous polypropylene elastomer”).

The term “lubricant” used in the present invention means a substance having a function to improve the sliding properties of a product surface during and after plastic molding process Examples of lubricants include stearic acid amide, calcium stearate, etc., and, if necessary, the pressure-sensitive adhesive described in the present invention can contain at least one of the above-mentioned lubricants within a range that dose not impair the object of the present invention (for example, 5 parts or less, relative to 100 parts of the total of the “hydrogenation product of styrene random copolymer” and the “amorphous polypropylene elastomer”).

In the present invention, with respect to the coating method for applying the pressure-sensitive adhesive, a various known method can be employed, but, for example, an extrusion coating method or a spread coating method is preferred.

The extrusion coating method is not limited to the methods mentioned below, but include a production method using co-extrusion of a single-layer or multilayer substrate resin with a pressure-sensitive adhesive, and a production method using extrusion melt coating of a pressure-sensitive adhesive onto a substrate film.

In the method using co-extrusion, the pressure-sensitive adhesive described in the present invention is preliminarily kneaded, for example, using an extruder equipped with a multilayer die, such as a feed block die or a multimanifold die, well-known to those skilled in the art, and then co-extruded with the above-mentioned substrate resin to form a film, producing the surface protective sheet of the present invention. In this case, the preset temperature of the film resin extruder is 100 to 280° C., preferably 150 to 240° C. The preset temperature of the adhesive extruder is 100 to 250° C., preferably 150 to 240° C. The preset temperature of the die is 100 to 280° C., preferably 150 to 240° C. The pulling speed is 0.1 to 300 m/min, preferably 5 to 100 in/min.

In the extrusion melt coating, for example, the preliminarily kneaded pressure-sensitive adhesive is melt extruded onto one surface of a substrate film, which has been subjected to corona treatment, release treatment (e.g., a long-chain alkyl release agent, a silicon release agent, etc.), and primer treatment, by using a T-die extruder to form a film, producing the surface protective sheet of the present invention. The preset temperature of the die is 100 to 280° C., preferably 150 to 240° C. The pulling speed is 0.1 to 300 m/min, preferably 5 to 100 m/min. In the extrusion melt coating, not only a thermoplastic film but also a non-thermoplastic substrate, such as paper, metal, woven fabric, nonwoven fabric, etc can be used as the substrate film.

The pressure-sensitive adhesive can be kneaded using a kneading apparatus, such as a single screw extruder, a twin screw extruder, a kneader, a Banbury mixer, etc.

The spread coating method include, but are not limited to the method mentioned below, for example, the surface protective sheet of the present invention can be produced by a method in which the pressure-sensitive adhesive described in the present invention is dissolved in a solvent, such as toluene or hexane, at a concentration of 5 to 45%, preferably 10 to 30%, and applied by a coating method well-known to those skilled in the art, followed by drying.

The substrate used in the present invention preferably has an ultraviolet transmittance at 190 to 400 nm of 1% or less, more preferably 0.5% or less, especially preferably 0.3% or less, as measured using a spectrophotometer (V-570, manufactured by JASCO Corporation).

### EXAMPLES

Hereinbelow, the present invention will be described in more detail with reference to the following Examples, which should not be construed as limiting the scope of the present invention.

### Example 1

Hydrogenation product of styrene random copolymer: DYNARON 1320P (hydrogenated styrene-butadiene rubber), manufactured by JSR Corporation 60 Parts
Amorphous polypropylene elastomer: Tafthren X1102, manufactured by Sumitomo Chemical Co., Ltd. 40 Parts
Tackifier resin 1: PINECRYSTAL KE311, manufactured by Arakawa Chemical Industries, Ltd. 8.5 Parts
Tackifier resin 2: Clearon K100, manufactured by YASUHARA CHEMICAL CO., LTD. 34.0 Parts
Softener: Polybutene HV300, manufactured by Nippon Petrochemicals Co, Ltd. 25.5 Parts
Antioxidant: Antage W500, manufactured by Kawaguchi Chemical Industry Co., Ltd. 0.5 Part
Ultraviolet absorber TINUVIN 326, manufactured by Ciba Specialty Chemicals Inc. 1.2 Parts

The adhesive composition shown above was preliminarily kneaded and then, the resultant adhesive composition was subjected to melt extrusion on one surface of a white polypropylene film (light transmittance: less than 0.5%) having a substrate thickness of 60 μm, which had been subjected to release treatment and primer treatment, using a T-die extruder at a T-die temperature of 240° C. and at a film pulling speed of 10 m/min to prepare a pressure-sensitive adhesive sheet having an adhesive thickness of 10 μn.

The white polypropylene film was prepared as follows. Polypropylene (Moplen 440G, MFR: 1.3 g/10 min (230° C., 2.16 kg)), manufactured by Basell Service Company, and titanium oxide (TIPAQUE A220), manufactured by ISHIHARA SANGYO KAISHA, LTD., were kneaded together in a 93:7 weight ratio using a twin-screw kneading extruder at 200° C., and then subjected to T-die extrusion method to prepare a white polypropylene film (light transmittance: less than 0.5%) having a thickness of 60 μm. The T-die extrusion method indicates a method for forming a film by extrusion of a molten resin through a narrow gap between heated dice, and the extrusion of a pressure-sensitive adhesive on a substrate enables preparation of a pressure-sensitive adhesive sheet. Further, simultaneous extrusion of two or three layers enables production of a multilayer film.

The release treatment for the white polypropylene film was performed by subjecting both surfaces of the white polypropylene film to corona treatment, and then coating a long-chain alkyl release agent onto one treated surface.

The primer treatment for the white polypropylene film was performed by coating acid-modified polypropylene (UNISTOLE (solids content: 5%), manufactured by Mitsui Chemicals, Inc.) dissolved in toluene onto the film.

### Comparative Example 1

Hydrogenation product of styrene random copolymer: DYNARON 1320P (hydrogenated styrene-butadiene rubber), manufactured by JSR Corporation 60 Parts
Ethylene-octene 1 copolymer elastomer: ENGAGE 8842, manufactured by DuPont Dow Elastomers L.L.C. 40 Parts
Tackifier resin 1: PINECRYSTAL KE311, manufactured by Arakawa Chemical Industries, Ltd. 8.5 Parts
Tackifier resin 2: Clearon K100, manufactured by YASUHARA CHEMICAL CO., LTD. 34.0 Parts
Softener: Polybutene HV300, manufactured by Nippon Petrochemicals Co., Ltd. 25.5 Parts
Antioxidant: Antage W500, manufactured by Kawaguchi Chemical Industry Co., Ltd. 0.5 Part
Ultraviolet absorber: TINUVIN 326, manufactured by Ciba Specialty Chemicals Inc. 1.2 Parts

Using the adhesive composition shown above, a pressure-sensitive adhesive sheet was prepared in the same manner as in Example 1

### Comparative Example 2

Hydrogenation product of styrene random copolymer: DYNARON 1320P (hydrogenated styrene-butadiene rubber), manufactured by JSR Corporation 60 Parts
Polypropylene resin: Prime Polypro F744NP, manufactured by Prime Polymer Co Ltd. 40 Parts
Tackifier resin 1: PINECRYSTAL KE311, manufactured by Arakawa Chemical Industries, Ltd. 8.5 Parts
Tackifier resin 2: Clearon K100, manufactured by YASUHARA CHEMICAL CO., LTD. 34.0 Parts
Softener: Polybutene HV300, manufactured by Nippon Petrochemicals Co., Ltd. 25.5 Parts
Antioxidant: Antage W500, manufactured by Kawaguchi Chemical Industry Co., Ltd. 0.5 Part
Ultraviolet absorber: TINUVIN 326, manufactured by Ciba Specialty Chemicals Inc. 1.2 Parts

Using the adhesive composition shown above, a pressure-sensitive adhesive sheet was prepared in the same manner as in Example 1

### Comparative Example 3

Hydrogenation product of styrene random copolymer: DYNARON 1320P (hydrogenated styrene-butadiene rubber), manufactured by TSR Corporation 0 Part
Amorphous polypropylene elastomer: Tafthren X1102, manufactured by Sumitomo Chemical Co., Ltd. 100 Parts
Tackifier resin 1: PINECRYSTAL KE311, manufactured by Arakawa Chemical Industries, Ltd. 8.5 Parts
Tackifier resin 2: Clearon K100, manufactured by YASUHARA CHEMICAL CO., LTD. 34.0 Parts
Softener: Polybutene HV300, manufactured by Nippon Petrochemicals Co., Ltd. 25.5 Parts
Antioxidant: Antage W500, manufactured by Kawaguchi Chemical Industry Co., Ltd. 0.5 Part
Ultraviolet absorber: TINUVIN 326, manufactured by Ciba Specialty Chemicals Inc. 1.2 Parts

Using the adhesive composition shown above; a pressure-sensitive adhesive sheet was prepared in the same manner as in Example 1.

### Example 2

Hydrogenation product of styrene random copolymer DYNARON 1320P (hydrogenated styrene-butadiene rubber), manufactured by JSR Corporation 20 Parts
Amorphous polypropylene elastomer: Tafthren X1102, manufactured by Sumitomo Chemical Co., Ltd. 80 Parts
Tackifier resin 1: PINECRYSTAL KE311, manufactured by Arakawa Chemical Industries, Ltd. 8.5 Parts
Tackifier resin 2 Clearon K100, manufactured by YASUHARA CHEMICAL CO., LTD. 34.0 Parts
Softener: Polybutene HV300, manufactured by Nippon Petrochemicals Co Ltd. 25.5 Parts
Antioxidant: Antage W500, manufactured by Kawaguchi Chemical Industry Co, Ltd. 0.5 Part
Ultraviolet absorber: TINUVIN 326, manufactured by Ciba Specialty Chemicals Inc. 1.2 Parts

Using the adhesive composition shown above, a pressure-sensitive adhesive sheet was prepared in the same manner as in Example 1.

### Example 3

Hydrogenation product of styrene random copolymer: DYNARON 1320P (hydrogenated styrene-butadiene rubber), manufactured by JSR Corporation 40 Parts
Amorphous polypropylene elastomer: Tafthren X1102, manufactured by Sumitomo Chemical Co., Ltd. 60 Parts
Tackifier resin 1: PINECRYSTAL KE311, manufactured by Arakawa Chemical Industries, Ltd. 8.5 Parts
Tackifier resin 2: Clearon K100, manufactured by YASUHARA CHEMICAL CO., LTD. 34.0 Parts
Softener: Polybutene HV300, manufactured by Nippon Petrochemicals Co., Ltd. 25.5 Parts
Antioxidant: Antage W500, manufactured by Kawaguchi Chemical Industry Co., Ltd. 0.5 Part
Ultraviolet absorber: TINUVIN 326, manufactured by Ciba Specialty Chemicals Inc. 1.2 Parts

Using the adhesive composition shown above, a pressure-sensitive adhesive sheet was prepared in the same manner as in Example 1.

### Example 4

Hydrogenation product of styrene random, copolymer: DYNARON 1320P (hydrogenated styrene-butadiene rubber), manufactured by JSR Corporation 50 Parts
Amorphous polypropylene elastomer: Tafthren X1102, manufactured by Sumitomo Chemical Co., Ltd. 50 Parts
Tackifier resin 1: PINECRYSTAL KE311, manufactured by Arakawa Chemical Industries, Ltd. 8.5 Parts
Tackifier resin 2: Clearon K100, manufactured by YASUHARA CHEMICAL CO., LTD. 34.0 Parts
Softener: Polybutene HV300, manufactured by Nippon Petrochemicals Co., Ltd. 25.5 Parts
Antioxidant: Antage W500, manufactured by Kawaguchi Chemical Industry Co., Ltd. 0.5 Part
Ultraviolet absorber: TINUVIN 326, manufactured by Ciba Specialty Chemicals Inc. 1.2 Parts

Using the adhesive composition shown above, a pressure-sensitive adhesive sheet was prepared in the same manner as in Example 1.

### Example 5

Hydrogenation product of styrene random copolymer: DYNARON 1320P (hydrogenated styrene-butadiene rubber), manufactured by JSR Corporation 55 Parts
Amorphous polypropylene elastomer: Tafthren X1102, manufactured by Sumitomo Chemical Co., Ltd. 45 Parts
Tackifier resin 1: PINECRYSTAL KE311, manufactured by Arakawa Chemical Industries, Ltd. 8.5 Parts
Tackifier resin 2: Clearon K100, manufactured by YASUHARA CHEMICAL CO., LTD. 34.0 Parts
Softener: Polybutene HV300, manufactured by Nippon Petrochemicals Co., Ltd. 25.5 Parts
Antioxidant: Antage W500, manufactured by Kawaguchi Chemical Industry Co., Ltd. 0.5 Part
Ultraviolet absorber: TINUVIN 326, manufactured by Ciba Specialty Chemicals Inc. 1.2 Parts

Using the adhesive composition shown above, a pressure-sensitive adhesive sheet was prepared in the same manner as in Example 1.

### Example 6

Hydrogenation product of styrene random copolymer: DYNARON 1320P (hydrogenated styrene-butadiene rubber), manufactured by JSR Corporation 65 Parts
Amorphous polypropylene elastomer: Tafthren X1102, manufactured by Sumitomo Chemical Co., Ltd. 35 Parts
Tackifier resin PINECRYSTAL KE311, manufactured by Arakawa Chemical Industries, Ltd. 8.5 Parts
Tackifier resin 2: Clearon K100, manufactured by YASUHARA CHEMICAL CO., LTD. 34.0 Parts
Softener: Polybutene HV300, manufactured by Nippon Petrochemicals Co., Ltd. 25.5 Parts
Antioxidant: Antage W500, manufactured by Kawaguchi Chemical Industry Co., Ltd. 0.5 Part
Ultraviolet absorber: TINUVIN 326, manufactured by Ciba Specialty Chemicals Inc 12 Parts

Using the adhesive composition shown above, a pressure-sensitive adhesive sheet was prepared in the same manner as in Example 1.

### Example 7

Hydrogenation product of styrene random copolymer: DYNARON 1320P (hydrogenated styrene-butadiene rubber), manufactured by JSR Corporation 70 Parts
Amorphous polypropylene elastomer: Tafthren X1102, manufactured by Sumitomo Chemical Co., Ltd. 30 Parts
Tackifier resin 1: PINECRYSTAL KE311, manufactured by Arakawa Chemical Industries, Ltd. 8.5 Parts
Tackifier resin 2 Clearon K100, manufactured by YASUHARA CHEMICAL CO., LTD. 340 Parts
Softener: Polybutene HV300, manufactured by Nippon Petrochemicals Co., Ltd. 25.5 Parts
Antioxidant: Antage W500, manufactured by Kawaguchi Chemical Industry Co., Ltd. 0.5 Part

Using the adhesive composition shown above, a pressure-sensitive adhesive sheet was prepared in the same manner as in Example 1.

### Comparative Example 4

Hydrogenation product of styrene random copolymer: DYNARON 1320P (hydrogenated styrene-butadiene rubber), manufactured by JSR Corporation 80 Parts
Amorphous polypropylene elastomer: Tafthren X1102, manufactured by Sumitomo Chemical Co., Ltd. 20 Parts
Tackifier resin 1: PINECRYSTAL KE311, manufactured by Arakawa Chemical Industries, Ltd. 8.5 Parts
Tackifier resin 2: Clearon K100, manufactured by YASUHARA CHEMICAL CO., LTD. 34.0 Parts
Softener: Polybutene HV300, manufactured by Nippon Petrochemicals Co., Ltd. 255 Parts
Antioxidant: Antage W500, manufactured by Kawaguchi Chemical Industry Co., Ltd. 0.5 Part
Ultraviolet absorber: TINUVIN 326, manufactured by Ciba Specialty Chemicals Inc. 1.2 Parts

Using the adhesive composition shown above, a pressure-sensitive adhesive sheet was prepared in the same manner as in Example 1.

### Comparative Example 5

Hydrogenation product of styrene random copolymer DYNARON 1320P (hydrogenated styrene-butadiene rubber), manufactured by JSR Corporation 100 Parts
Amorphous polypropylene elastomer: Tafthren X1102, manufactured by Sumitomo Chemical Co Ltd. 0 Part
Tackifier resin 1: PINECRYSTAL KE311, manufactured by Arakawa Chemical Industries, Ltd. 8.5 Parts
Tackifier resin 2: Clearon K100, manufactured by YASUHARA CHEMICAL CO., LTD. 34.0 Parts
Softener: Polybutene HV300, manufactured by Nippon Petrochemicals Co., Ltd. 25.5 Parts
Antioxidant: Antage W500, manufactured by Kawaguchi Chemical Industry Co., Ltd. 0.5 Part
Ultraviolet absorber: TINUVIN 326, manufactured by Ciba Specialty Chemicals Inc. 1.2 Parts

Using the adhesive composition shown above, a pressure-sensitive adhesive sheet was prepared in the same manner as in Example 1

### Comparative Example 6

Styrene copolymer: SIBSTER 072TP (styrene-isobutylene block copolymer), manufactured by Kaneka Corporation 20 Parts
Amorphous polypropylene elastomer: Tafthren X1102, manufactured by Sumitomo Chemical Co., Ltd. 80 Parts
Tackifier resin 1. PINECRYSTAL KE311, manufactured by Arakawa Chemical Industries, Ltd. 8.5 Parts
Tackifier resin 2: Clearon K100, manufactured by YASUHARA CHEMICAL CO., LTD. 34.0 Parts
Softener: Polybutene HV300, manufactured by Nippon Petrochemicals Co., Ltd. 25.5 Parts
Antioxidant: Antage W500, manufactured by Kawaguchi Chemical Industry Co., Ltd. 0.5 Part
Ultraviolet absorber TINUVIN 326, manufactured by Ciba Specialty Chemicals Inc. 1.2 Parts

Using the adhesive composition shown above, a pressure-sensitive adhesive sheet was prepared in the same manner as in Example 1.

### 23° C., −20° C., or 70° C. Adhesion Strength Test

An adhesive strength to coating was measured in accordance with JIS Z0237 under adhesive strength to coating 180′ peel force, adherend poorly adhesive acrylic coating*; peel rate: 0.3 m/min, and measured atmosphere 23° C., −20° C., or 70° C.

### Peeling Workability Test

For evaluating the peeling workability, an adhesive strength to coating was measured under high-speed peeling conditions.

A pretreatment: heating at 70° C. for 5 hours was performed and then natural cooling to room temperature (23° C.) was conducted, and then an adhesive strength to coating was measured in accordance with JIS Z 0237 under adhesive strength to coating 180° peel force; adherend poorly adhesive acrylic coating*, peel rate 40 m/min, and measured atmosphere: 23° C.
With respect to the poorly adhesive acrylic coating, a poorly adhesive acrylic coating clear for automobile, manufactured by NIPPON PAINT Co., Ltd. or Kansai Paint Co., Ltd., having a wettability of less than 30 dyn/cm (as measured in accordance with JIS K6768) was used

### Test for Sticking Trace on Coating

To a plate coated with a poorly adhesive acrylic coating* was sticked a pressure-sensitive adhesive sheet while causing wrinkling, and the resultant coated plate was heated at 80° C. for 24 hours, and then allowed to cool on standing to room temperature, and the pressure-sensitive adhesive sheet was peeled off the coated plate. Then, a uneven of the coating caused between the portion of the coating onto which the wrinkling portion of the adhesive sheet had been sticked and the portion of the coating onto which the non-wrinkling portion of the adhesive sheet had been sticked was measured using a surface roughness meter (SURFCORDER ET4000A, manufactured by Kosaka Laboratory Ltd.). A sticking trace on coating of 0.17 μm or less was rated “◯ (excellent)”, and 0.18 μm or more was rated “x (poor)”

### Low-Temperature Adhesion Test

A pressure-sensitive adhesive sheet having width: 50 mm×length: 110 mm was sticked to a coated plate, and then peeled off the coated plate by 10 mm in the lengthwise direction of the sheet to form a turned edge. The resultant coated plate having a turned edge of the pressure-sensitive adhesive sheet was used as a test specimen. Then, the test specimen was allowed to stand at 23° C. for 20 minute and then at −20° C. for 40 minutes, and subsequently, air was sprayed toward the turned edge portion of the test specimen in an atmosphere at −20° C. by means of an air gun positioned away from the test specimen at a distance of 5 mm for 3 seconds, and the presence or absence of peel-off was evaluated. Air gun nozzle diameter: 1.5 mm φ; compressor pump pressure: 1.5 to 1.0 kg/cm²

TABLE 1

| | | Comparative | Comparative | Comparative | | | | | | | Comparative | Comparative | Comparative |
|---|---|---|---|---|---|---|---|---|---|---|---|---|---|
| Formulation | Example 1 | example 1 | example 2 | example 3 | Example 2 | Example 3 | Example 4 | Example 5 | Example 6 | Example 7 | example 4 | example 5 | example 6 |
| DYNARON 1320P | 60 | 60 | 60 | 0 | 20 | 40 | 50 | 55 | 65 | 70 | 80 | 100 | |
| Tafthren X1102 | 40 | | | 100 | 80 | 60 | 50 | 45 | 35 | 30 | 20 | 0 | 80 |
| ENGAGE 8842 | | 40 | | | | | | | | | | | |
| Polypro F744NP | | | 40 | | | | | | | | | | |
| SIBSTER 072T | | | | | | | | | | | | | 20 |
| PINECRYSTAL KE311 | 8.5 | 8.5 | 8.5 | 8.5 | 8.5 | 8.5 | 8.5 | 8.5 | 8.5 | 8.5 | 8.5 | 8.5 | 8.5 |
| Clearon K100 | 34 | 34 | 34 | 34 | 34 | 34 | 34 | 34 | 34 | 34 | 34 | 34 | 34 |
| Polybutene HV300 | 25.5 | 25.5 | 25.5 | 25.5 | 25.5 | 25.5 | 25.5 | 25.5 | 25.5 | 25.5 | 25.5 | 25.5 | 25.5 |
| Antage W500 | 0.5 | 0.5 | 0.5 | 0.5 | 0.5 | 0.5 | 0.5 | 0.5 | 0.5 | 0.5 | 0.5 | 0.5 | 0.5 |
| TINUVIN 326 | 1.2 | 1.2 | 1.2 | 1.2 | 1.2 | 1.2 | 1.2 | 1.2 | 1.2 | 1.2 | 1.2 | 1.2 | 1.2 |
| Property value | | | | | | | | | | | | | |
| 23° C. Adhesion strength | 3.6 | 2.5 | 2.2 | 5.5 | 4.0 | 3.6 | 3.7 | 3.5 | 3.3 | 3.4 | 3.5 | 3.3 | Not |
| Coating by NIPPON PAINT | | | | | | | | | | | | | measured |
| Co., Ltd. (N/15 mm) | | | | | | | | | | | | | |
| 23° C. Adhesion strength | 4.1 | 2.8 | 3.0 | 7.1 | 4.5 | 4.1 | 4.5 | 4.3 | 4.2 | 4.0 | 4.1 | 2.2 | Not |
| Coating by Kansai Paint | | | | | | | | | | | | | measured |
| Co., Ltd. (N/15 mm) | | | | | | | | | | | | | |
| −20° C. Adhesion strength | 0.3 | 0.9 | 0.3 | 1.7 | 0.3 | 0.3 | 0.4 | 0.6 | 0.8 | 0.5 | 1.0 | 0.8 | Not |
| Coating by NIPPON PAINT | | | | x | | | | | | | | | measured |
| Co., Ltd. (N/15 mm) | | | | Adhesive | | | | | | | | | |
| | | | | residue | | | | | | | | | |
| −20° C. Adhesion strength | 4.1 | 2.2 | 0.5 | 2.3 | 2.4 | 2.3 | 2.2 | 2.8 | 2.2 | 1.7 | 2.7 | 1.5 | Not |
| Coating by Kansai Paint Co., | | | | x | | | | | | | | | measured |
| Ltd. (N/15 mm) | | | | Adhesive | | | | | | | | | |
| | | | | residue | | | | | | | | | |
| 70° C. Adhesion strength | 1.2 | 1.9 | Not | Not | 2.7 | 2.5 | 2.3 | 1.6 | 1.5 | 2.1 | 1.8 | Not | Not |
| Coating by NIPPON PAINT Co., | ∘ | x | measured | measured | ∘ | ∘ | ∘ | ∘ | ∘ | ∘ | ∘ | measured | measured |
| Ltd. (N/15 mm) | | Adhesive | | | | | | | | | | | |
| | | residue | | | | | | | | | | | |
| Peeling workability | 6.1 | 6.3 | 3.5 | 10.6 | 5.9 | 9.9 | 9.9 | 9.5 | 9.0 | 9.8 | 9.6 | 8.7 | Not |
| Coating by NIPPON PAINT | | | | | | | | | | | | | measured |
| Co., Ltd. (N/15 mm) | | | | | | | | | | | | | |
| Peeling workability Coating by | 5.4 | 4.9 | 4.1 | 6.6 | 4.4 | 3.0 | 3.1 | 2.4 | 1.8 | 1.8 | 2.1 | 2.2 | Not |
| Kansai Paint Co., Ltd. | | | | | | | | | | | | | measured |
| (N/15 mm) | | | | | | | | | | | | | |
| Sticking trace on coating (μm) | 0.10 | Not | Not | Not | 0.14 | 0.14 | 0.14 | 0.12 | 0.13 | 0.15 | 0.18 | Not | Not |
| (Measurement of uneven) | ∘ | measured | measured | measured | ∘ | ∘ | ∘ | ∘ | ∘ | ∘ | x | measured | measured |
| Low-temperature adhesion | ∘ | ∘ | x | x | ∘ | ∘ | ∘ | ∘ | ∘ | ∘ | ∘ | x | x |
| Coating by NIPPON PAINT | | | | | | | | | | | | | |
| Co., Ltd. | | | | | | | | | | | | | |
| Overall evaluation | ∘ | x | x | x | ∘ | ∘ | ∘ | ∘ | ∘ | ∘ | x | x | x |

* Sticking trace on coating: ∘ = 0.17 or less; x = 0.18 or more

### Results

As can be seen from Table 1, each of Examples 1 to 7 had appropriate adhesion strength to the coating at ordinary temperature (23° C. adhesion strength), and caused no adhesive residue. In addition, also in the low-temperature adhesion test, an excellent result was obtained such that no adhesive residue was caused. Also in the adhesion strength after heating at 70° C. (70° C. adhesion strength), an excellent result was obtained such that no adhesive residue was caused. Further, almost no uneven on the coating due to a sticking trace (sticking trace on coating) was caused, and the trace on the coating after peeling the tape off the coating was not noticeable. Furthermore, also in the low-temperature adhesion test for testing the practical use under winter conditions, excellent results were obtained.

In contrast, Comparative Example 1 has a trouble to cause an adhesive residue in the measurement of an adhesion strength after heating at 70° C. (70° C. adhesion strength).

Comparative Examples 2 and 3 have a trouble to cause peeling in the low-temperature adhesion test.

Comparative Example 4 has a trouble to cause a marked sticking trace.

Comparative Examples 5 and 6 have a trouble to cause peeling in the low-temperature adhesion test.

### INDUSTRIAL APPLICABILITY

The present invention can be used for the purpose of protecting, for example, a metal surface, a glass surface, a plastic surface, a rubber surface, a coating surface, etc. Particularly, with respect to the coating finished car during transport or storage outdoors, the present invention can be used for protecting the topcoat surface on the car body surface from, for example, a damage, a lowering of luster, and a change in color.

1. A surface protective sheet having a pressure-sensitive adhesive on at least one surface of a substrate, characterized in that the pressure-sensitive adhesive comprises a hydrogenation product of styrene random copolymer, an amorphous polypropylene elastomer, a tackifier resin, and a softener,
wherein the hydrogenation product of styrene random copolymer:the amorphous polypropylene elastomer=more than 0:less less than 100 to less than 80:more than 20, when the total of the hydrogenation product of styrene random copolymer and the amorphous polypropylene elastomer is taken as 100.

2. The surface protective sheet according to claim 1, wherein the hydrogenation product of styrene random copolymer is a hydrogenation product of a styrene-butadiene random copolymer.

3. The surface protective sheet according to claim 1, characterized in that the tackifier resin is comprised of a hydrogenated rosin ester resin and/or a hydrogenated terpene resin.

4. The surface protective sheet according to claim 1, wherein the softener is at least one selected among an oil, a paraffin wax, a low molecular-weight polybutene, a low molecular-weight polyisoprene, and a low molecular-weight polyisobutylene.

5. The surface protective sheet according to claim 1, characterized in that the pressure-sensitive adhesive contains at least one selected among an antioxidant, an ultraviolet absorber, an ultraviolet stabilizer (HALS), an antistatic agent, and a lubricant.

6. The surface protective sheet according to claim 2, characterized in that the tackifier resin is comprised of a hydrogenated rosin ester resin and/or a hydrogenated terpene resin.

7. The surface protective sheet according to claim 2, wherein the softener is at least one selected among an oil, a paraffin wax, a low molecular-weight polybutene, a low molecular-weight polyisoprene, and a low molecular-weight polyisobutylene.

8. The surface protective sheet according to claim 3, wherein the softener is at least one selected among an oil, a paraffin wax, a low molecular-weight polybutene, a low molecular-weight polyisoprene, and a low molecular-weight polyisobutylene.

9. The surface protective sheet according to claim 6, wherein the softener is at least one selected among an oil, a paraffin wax, a low molecular-weight polybutene, a low molecular-weight polyisoprene, and a low molecular-weight polyisobutylene.

10. The surface protective sheet according to claim 2, characterized in that the pressure-sensitive adhesive contains at least one selected among an antioxidant, an ultraviolet absorber, an ultraviolet stabilizer (HALS), an antistatic agent, and a lubricant.

11. The surface protective sheet according to claim 3, characterized in that the pressure-sensitive adhesive contains at least one selected among an antioxidant, an ultraviolet absorber, an ultraviolet stabilizer (HALS), an antistatic agent, and a lubricant.

12. The surface protective sheet according to claim 4, characterized in that the pressure-sensitive adhesive contains at least one selected among an antioxidant, an ultraviolet absorber, an ultraviolet stabilizer (HALS), an antistatic agent, and a lubricant.

13. The surface protective sheet according to claim 6, characterized in that the pressure-sensitive adhesive contains at least one selected among an antioxidant, an ultraviolet absorber, an ultraviolet stabilizer (HALS), an antistatic agent, and a lubricant.

14. The surface protective sheet according to claim 7, characterized in that the pressure-sensitive adhesive contains at least one selected among an antioxidant, an ultraviolet absorber, an ultraviolet stabilizer (HALS), an antistatic agent, and a lubricant.

15. The surface protective sheet according to claim 8, characterized in that the pressure-sensitive adhesive contains at least one selected among an antioxidant, an ultraviolet absorber, an ultraviolet stabilizer (HALS), an antistatic agent, and a lubricant.

16. The surface protective sheet according to claim 9, characterized in that the pressure-sensitive adhesive contains at least one selected among an antioxidant, an ultraviolet absorber, an ultraviolet stabilizer (HALS), an antistatic agent, and a lubricant.
